(19) United States
(12) Patent Application Publication
(10) Pub. No.: US 2015/0217215 A1
(43) Pub. Date: Aug. 6, 2015

(54) APPARATUS FOR REMOVING WATER FROM A HYDROCARBON TANK AND METHOD OF USE THEREOF

(71) Applicant: Can-Ross Environmental Services Ltd., Oakville (CA)

(72) Inventors: Ted Edgar, Oakville (CA); Terry Edgar, Oakville (CA)

(73) Assignee: Can-Ross Environmental Services Ltd., Oakville (CA)

(21) Appl. No.: 14/169,767

(22) Filed: Jan. 31, 2014

(51) Int. Cl. B01D 35/00

(52) U.S. Cl. CPC B01D 35/005

(57) ABSTRACT

An apparatus for removing water from oil comprises
a) a closed flexible outer water permeable container;
b) a closed flexible inner water permeable container positioned interior of the outer water permeable container;
c) a particulate water absorbent material positioned inside the inner water permeable container; and,
d) a grommet in the outer water permeable container
   wherein the outer water permeable container has a length, a first end and a second opposed end spaced lengthwise from the first end, the grommet is provided at the first end of the outer water permeable container and the inner container is positioned between the second opposed end of the outer container and the grommet.

### FIELD

This disclosure relates to a method and apparatus for removing water from the hydrocarbon and, in particular, from hydrocarbon stored in a tank. In particular embodiments, the method and apparatus relate to a double walled flexible holder for removing water from a hydrocarbon such as fuel stored in a fuel tank.

### BACKGROUND OF THE INVENTION

Water is a known contaminant of hydrocarbon such as fuel. If fuel is contaminated with water, this can result in a filter plugging as well as damage to engine fuel systems. When water and fuel are mixed, microbial growth and bio-degradation of fuel can cause a fuel injector system to fail over time. Further, if water is left in a fuel tank, then an environment is created wherein rust may occur, thereby increasing the possibility of fuel tank perforating.

Apparatus for removing water from oil tanks are known. See for example GB 2,109,401 (Ikinobu). Ikinobu discloses a device for removing water within oil tanks using a water-permeable container containing a water absorbing material. See also U.S. Pat. No. 4,861,470 (Casey) and U.S. Pat. No. 5,672,277 (Parker et al.). Various types of water absorbent material are known. See for example U.S. Pat. No. 5,830,543; U.S. Pat. No. 6,623,848; U.S. Pat. No. 7,745,537; and, US 2007/000093766.

### SUMMARY OF THE INVENTION

In accordance with this disclosure, there is provided an apparatus for removing water from a hydrocarbon such as fuel comprising a double walled holder (e.g. an inner and an outer flexible container assembly). In accordance with this aspect, the water absorbent material is provided in the inner water permeable container. The inner water permeable container is positioned within the outer water permeable container. Preferably, the outer water permeable container may be fabricated from a material having elasticity than the material of the inner water permeable container. As the water absorbent material swells, the inner water permeable container expands. If the outer water permeable container has more elasticity then the inner water permeable container, then the outer water permeable container may deform more as it is withdrawn from the inlet of a tank, This permits the apparatus to be withdrawn from a tank after use while reducing the likelihood that the outer container may rip, thereby protecting the inner container.

An advantage of this design is that the water absorbent material, which may be a water absorbent polymer, is secured within a double walled container. In the embodiment of FIG. 9 of Ikinobu, a water absorbent material is provided in a container 9 and a lid 10 is screwed onto the container. If the container were to break or leak, the water absorbent material could exit the container. In contrast, either the outer or the inner container of the double-walled holder of this disclosure could rupture and the water-absorbent material would still be retained within the holder. Accordingly, the likelihood that the water absorbent material, such as a water absorbent polymer, will contaminate an oil tank is reduced.

In accordance with this aspect, there is provided an apparatus comprising for removing water from oil comprising:
(a) a closed flexible outer water permeable container;
(b) a closed flexible inner water permeable container positioned interior of the outer water permeable container;
(c) a particulate water absorbent material positioned inside the inner water permeable container; and,
(d) a grommet in the outer water permeable container
wherein the outer water permeable container has a length, a first end and a second opposed end spaced lengthwise from the first end, the grommet is provided at the first end of the outer water permeable container, and the inner container is positioned between the second opposed end of the outer container and the grommet whereby the inner container is spaced from the elongate member when the elongate member extends through the grommet and when the water absorbent material has absorbed water.

In accordance with any of these embodiments, the inner water permeable container may be freely moveable within the outer water permeable container.

In accordance with any of these embodiments, the apparatus may further comprise a weight interior of the outer water permeable container and positionable at the second opposed end.

In accordance with this aspect, there is also provided an apparatus for removing water from oil comprising:
(a) a closed flexible outer water permeable container;
(b) a closed flexible inner water permeable container positioned interior of the outer water permeable container and freely moveable within the outer water permeable container; and,
(c) a particulate water absorbent material positioned inside the inner water permeable container.
In accordance with any of these embodiments, the apparatus may further comprise a weight interior of the outer water permeable container and positionable at the second opposed end.

In accordance with this aspect, there is also provided an apparatus for removing water from oil comprising:
(a) a closed flexible outer water permeable container;
(b) a closed flexible inner water permeable container positioned interior of the outer water permeable container;
(c) a particulate water absorbent material positioned inside the inner water permeable container; and,
(d) a weight interior of the outer water permeable container and positionable at the second opposed end.

In accordance with any of these embodiments, the inner water permeable container may comprise a material having a level of elasticity than the outer water permeable container.

In accordance with any of these embodiments, the inner water permeable container may comprise non-woven polypropylene.

In accordance with any of these embodiments, the outer water permeable container may be made of woven material and the inner water permeable container may be made of a non-woven material.

In accordance with any of these embodiments, the outer water permeable container may be made of woven polyester.

In accordance with any of these embodiments, the apparatus may further comprise an elongate flexible member that is connected to the outer water permeable container.

In accordance with any of these embodiments, the apparatus may further comprise a grommet provided in first and second opposed panels of the outer water permeable container and the elongate flexible member may be connected to the grommet and the inner water permeable container may be moveable with respect to the grommet.

In accordance with any of these embodiments, the outer water permeable container has a length, a first end and a second opposed end spaced lengthwise from the first end, the grommet may be provided at the first end of the outer water permeable container, and the inner container may be positioned between the second opposed end of the outer container and the grommet.

In accordance with any of these embodiments, the inner water permeable container may be freely moveable within the outer water permeable container.

In accordance with any of these embodiments, each of the inner and outer water permeable containers may comprise a plurality of pores and the pores of the inner water permeable container may be smaller than the pores of the outer water permeable container.

In accordance with any of these embodiments, the outer water permeable container may have pores from 250 to 500 and the inner water permeable container may have pores form 100 to 300.

In accordance with any of these embodiments, the water absorbent material may comprise a water absorbent polymer.

In accordance with any of these embodiments, the inner water permeable container may have a volume at least equal to the volume of the water absorbent material subsequent to the water absorbent material absorbing water.

In accordance with any of these embodiments, the apparatus may further comprise a weight interior of the outer water permeable container and positionable at the second opposed end.

In accordance with any of these embodiments, the weight may be interior of the inner water permeable container and may be freely moveable therein.

### DESCRIPTION OF THE DRAWINGS

The drawings included herewith are for illustrating various examples of articles, methods, and apparatuses of the teaching of the present specification and are not intended to limit the scope of what is taught in any way.

FIG. 1 is a cross-sectional view of a tank containing the apparatus;

FIG. 2 is a perspective view of the apparatus; and,

FIG. 3 is a perspective, partially broken away view of the apparatus of FIG. 2.

### DESCRIPTION OF THE PREFERRED EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present specification,” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

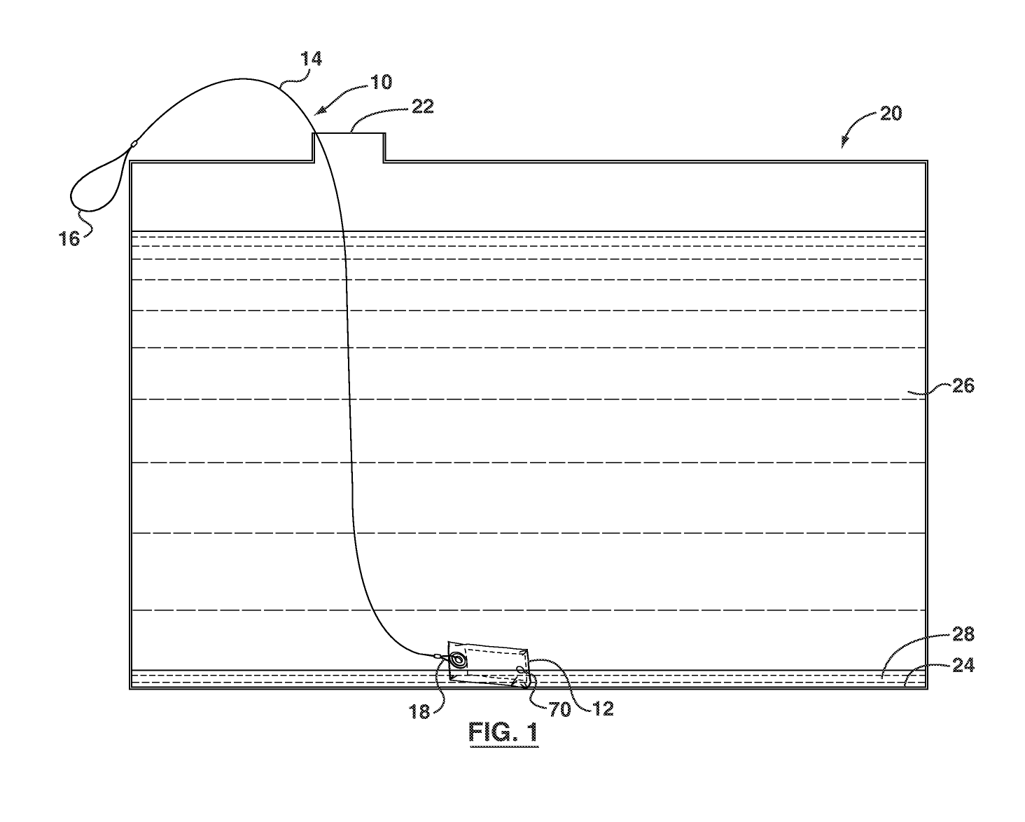

As exemplified in FIG. 1, apparatus 10 comprises a holder 12 and an elongate member 14 having a first end 16 and a second end 18.

As shown in FIG. 1, holder 10 is positioned in a tank 20 having an opening 22 and a bottom 24. Typically fuel and oil will separate over time. Accordingly, tank 20 may comprise a hydrocarbon such as fuel 26 which is lighter than water 28. Accordingly, water 28 will tend to accumulate on the bottom 24 of tank 20 and, accordingly, holder 20 is preferably placed on or adjacent bottom 24 so as to be exposed to, or fully within, the layer of water 28 in tank 20. It will be appreciated that tank 20 may be of any particular design and of any particular use.

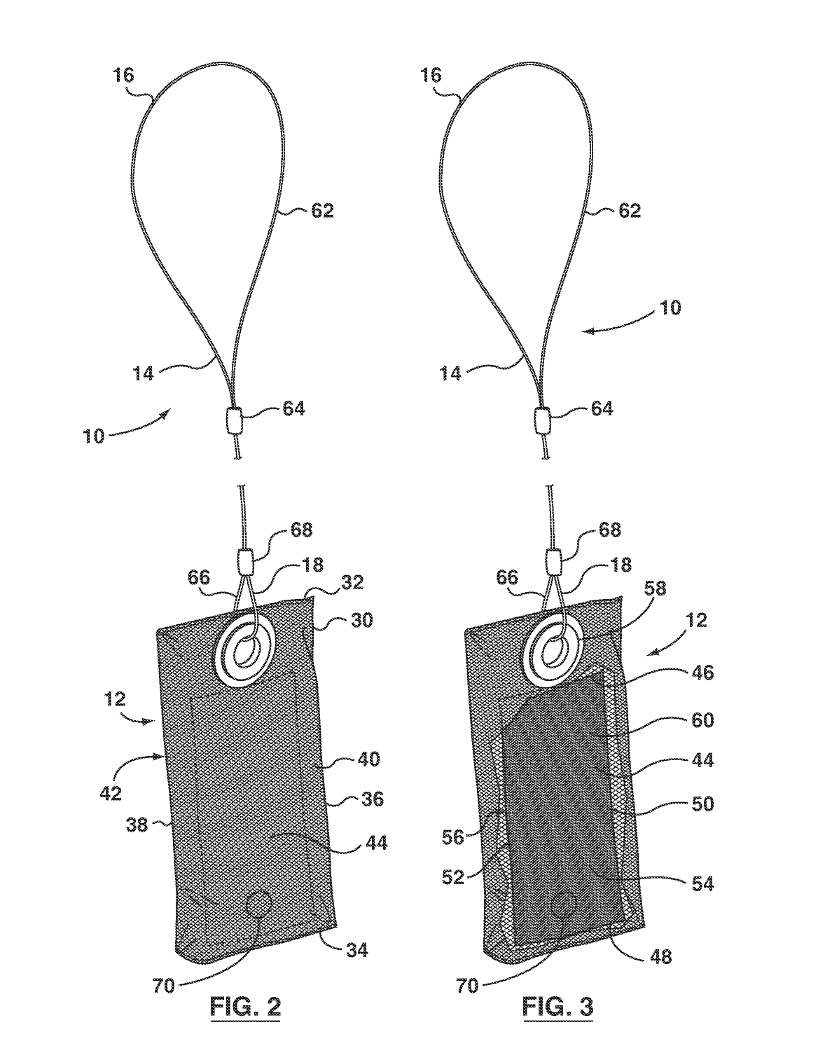

As exemplified in FIGS. 2 and 3, holder 12 comprises an outer water permeable container 30 having a first end 32 and a second end 34 that is spaced from first end 32 in a lengthwise direction. Outer water permeable container 30 also has first and second sides 36, 38 that extend between first and second ends 32, 34. Outer water permeable container 30 has a first panel 40 and an opposed second panel 42. As exemplified, each panel extends between first and second ends 32, 34 and first and second sides 36, 38.

Positioned interior of outer water permeable container 30 is inner water permeable container 44. Inner water permeable container 44 has a first end 46 and a second end 48 that is spaced from first end 46 in a lengthwise direction. Inner water permeable container 44 also has first and second sides 50, 52 that extend between first and second ends 46, 48. Outer water permeable container 44 has a first panel 54 and an opposed second panel 56. As exemplified, each panel extends between first and second ends 46, 48 and first and second sides 50, 52.

It will be appreciated that each of containers 30 and 44 may be of any particular size as long as inner container is positioned within outer container 30. For example, inner water permeable container 44 may be shorter than the distance from grommet 58 to second end 34 of outer water permeable container 30. Alternately, or in addition, inner water permeable container 44 may be folder so as to extend between grommet 58 and second end 34 of outer water permeable container 30.

Inner water permeable container 44 contains a water absorbent material 60. Water absorbent material 60 may be any solid water absorbent material known in the art. Preferably, water absorbent material 60 is a particulate material that is hydrophilic and oilophobic. Water absorbent material 60 may be a water absorbent polymer such as a copolymer of acrylate and acrylamide. Water absorbent material 60 preferably has a size greater than the pore size of the inner water permeable container. For example, the size of the particles of water absorbent material 60 may be 800-1,500 microns.

As the particulate water absorbent material 60 absorbs water, it will increase in volume (e.g., it will swell). Preferably, inner water permeable container 44 has an interior volume such that, when particulate water absorbent material 60 has absorbed the full amount of water which it is capable of absorbing, the interior volume of inner water permeable container 44 is at least the same as the volume of the swollen water absorbent material, and, preferably, slightly larger.

Each of inner and outer water permeable containers 44 and 30 are flexible and may be made of a natural or a synthetic or manmade material and, preferably, a plastic material. The material may be woven or non-woven (e.g., spun bond).

Outer water permeable container 30 may be made of a single material. Accordingly, a single sheet of material may be obtained and folded with the edges joined together such as by sewing, welding, an adhesive, or the like, to form a closed container. Alternately, outer water permeable container 30 may be formed from a series of panels which may be secured together such as by sewing, welding, an adhesive or the like. It will be appreciated that the panels may be made of the same material or different materials. The inner water permeable container 44 may be made in the same manner as the other water permeable container 30 or in a different way. Further, inner and outer water permeable containers 30 and 44 may be made from the same material or from different materials.

Preferably, the inner water permeable container 44 is made of a non-woven material and may be made of polypropylene. An advantage of non-woven material is that they tend to have less stretch. Accordingly, the size of the pores will tend to remain more constant than if the material were elastic or stretched. Therefore, the water absorbent material is less likely to leak out of the inner container.

Preferably, the outer water permeable container 30 is made of woven material and may be made of polyester. An advantage of woven materials is that the weave provides some elasticity or stretch to the resultant material. This quality assists in the apparatus being removed from the inlet of a fuel tank with a reduce likelihood that the outer container may rip.

Alternately, or in addition, outer water permeable container 30 may be made out of a stronger material than inner water permeable container 44. For example, the outer water permeable container 30 may have higher abrasion resistance or tensile strength than the material from which the inner water permeable container 44 is made.

An advantage of this design is that a softer and more flexible material may be utilized to form the inner water permeable container 44.

It will be appreciated that each of the inner and the outer water permeable containers 44 and 30 may have the same pore sizes or different pore sizes. Preferably the inner container has smaller pores than the outer container. For example, the pore size of the inner container may be from 250 to 500 microns, and the pore size of the outer container may be from 100 to 300 microns.

Elongate member 16 may be a rope or a cable and may be made from a natural or synthetic flexible material. Preferably, elongate member 16 is made from metal, such as a braided metal cord, e.g., stainless steel. Elongate member 16 may be of any desired lengths. Elongate member 16 preferably has a length such that first end 16 may be positioned outside of tank 20 and holder 12 may be positioned on the bottom of tank 20.

Each of first and second ends 16 and 18 of elongate member 14 may be of any design. As exemplified in FIG. 2, first end 16 comprises a loop. As exemplified therein, the end of the elongate member is secured in position by a compression member 64 so as to form loop 62. Similarly, second end 18 may comprise a loop 66 which is formed with a compression member 68. An advantage of this design is that the ends of the elongate member (which may be metal and may be sharp) are not exposed. An exposed end might provide a sharp surface against which outer water permeable container 30 may catch and rip.

Elongate member 16 may be secured to holder 12 by any means known in the art. Preferably, elongate member 16 is secured by passing an end of the elongate member 16 through first and second opposed panels 40 and 42. Preferably, a grommet 58 is provided such that loop 66 extends through grommet. An advantage of this design is that the grommet is provided on panels 40, 42. Preferably, grommet 58 does not extend past the perimeter of outer water permeable container 30 and therefore does not provide a sharp exposed end.

As exemplified in FIGS. 2 and 3, grommet 58 is provided at the first end 32 of outer water permeable container 30 and inner water permeable container 44 preferably has a length or is configured (e.g., folded) such that inner water permeable container 44 extends from second end 34 of outer container 30 and terminates at or before grommet 58. Accordingly, grommet 58 may not extend through inner water permeable container 44. It will be appreciated that portions of the inner container 44 may extend upwardly to either lateral side of grommet 58.

Preferably, inner water permeable container 44 is freely moveable within outer water permeable container 30. For example, inner and outer containers 44 and 30 may not be connected together. Instead, inner water permeable container 44 may be formed. Outer water permeable container 30 may then be formed e.g. with an open top. Inner water permeable container 44 may then be inserted through the open top and the open top of outer water permeable container 30 may then be sealed and grommet 58 installed. Accordingly, if a portion of outer container 30 rips, inner container 44 is freely moveable within the volume of outer container 30 and is less likely to also rip.

A weight 70 may be provided to assist second end 34 of outer container 30 settling on the bottom of tank 20. Accordingly, the weight 70 may be provided interior of outer container 30 and, preferably, interior of inner container 44. For example, weight 70 may be freely moveable inside inner container 44.

In operation, holder 12 may be inserted through opening 22 in tank 20 and lowered, preferably, to bottom 24. Weight 70 will tend to cause second opposed 34 to be the lower point of holder 12 as it is inserted into tank 20. Holder 12 is preferably lowered to bottom 24 of tank 20. Due to weight 70, holder 12 may tend to lie flat on bottom 24 and not fold on itself. Accordingly, all of absorbent material 60 may be positioned adjacent bottom 24 and situated so as to absorb water 28. Holder 12 may be retained in tank any desirable amount of time but, preferably, sufficient amount of time to absorb a desired amount of water 28. For example, holder 12 may be left in tank 20 for 12-36 hours, and preferably about 24 hours. After the desired time, holder 12 is removed from tank 20 such as by pulling on first end 16 of elongate member 14.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole

1) An apparatus for removing water from oil comprising:
a) a closed flexible outer water permeable container;
b) a closed flexible inner water permeable container positioned interior of the outer water permeable container;
c) a particulate water absorbent material positioned inside the inner water permeable container; and,
d) a grommet in the outer water permeable container
wherein the outer water permeable container has a length, a first end and a second opposed end spaced lengthwise from the first end, the grommet is provided at the first end of the outer water permeable container, and the inner container positioned between the second opposed end of the outer container and the grommet whereby the inner container is spaced from the elongate member when the elongate member extends through the grommet and when the water absorbent material has absorbed water.

2) The apparatus of claim 1 wherein the inner water permeable container is freely moveable within the outer water permeable container.

3) The apparatus of claim 1 further comprising a weight interior of the outer water permeable container and positionable at the second opposed end.

4) An apparatus for removing water from oil comprising:
a) a closed flexible outer water permeable container;
b) a closed flexible inner water permeable container positioned interior of the outer water permeable container and freely moveable within the outer water permeable container; and,
c) a particulate water absorbent material positioned inside the inner water permeable container.

5) The apparatus of claim 4 further comprising a weight interior of the outer water permeable container and positionable at the second opposed end.

6) An apparatus for removing water from oil comprising:
a) a closed flexible outer water permeable container;
b) a closed flexible inner water permeable container positioned interior of the outer water permeable container;
c) a particulate water absorbent material positioned inside the inner water permeable container; and,
d) a weight interior of the outer water permeable container and positionable at the second opposed end.

7) The apparatus of claim 6 wherein the inner water permeable container comprises a material having a level of elasticity than the outer water permeable container.

8) The apparatus of claim 6 wherein the inner water permeable container comprises non-woven polypropylene.

9) The apparatus of claim 6 wherein the outer water permeable container is made of woven material and the inner water permeable container is made of a non-woven material.

10) The apparatus of claim 8 wherein the outer water permeable container is made of woven polyester.

11) The apparatus of claim 6 further comprising an elongate flexible member that is connected to the outer water permeable container.

12) The apparatus of claim 6 further comprising a grommet provided in first and second opposed panels of the outer water permeable container and the elongate flexible member is connected to the grommet and the inner water permeable container is moveable with respect to the grommet.

13) The apparatus of claim 6 wherein the outer water permeable container has a length, a first end and a second opposed end spaced lengthwise from the first end, the grommet is provided at the first end of the outer water permeable container, and the inner container positioned between the second opposed end of the outer container and the grommet.

14) The apparatus of claim 6 wherein the inner water permeable container is freely moveable within the outer water permeable container.

15) The apparatus of claim 1 wherein each of the inner and outer water permeable containers comprises a plurality of pores and the pores of the inner water permeable container are smaller than the pores of the outer water permeable container.

16) The apparatus of claim 15 wherein the outer water permeable container has pores from 250 to 500 and the inner water permeable container has pores form 100 to 300.

17) The apparatus of claim 6 wherein the water absorbent material comprises a water absorbent polymer.

18) The apparatus of claim 6 wherein the inner water permeable container has a volume at least equal to the volume of the water absorbent material subsequent to the water absorbent material absorbing water.

19) The apparatus of claim 6 wherein the weight is interior of the inner water permeable container.
